(19) United States
(12) Patent Application Publication
(10) Pub. No.: US 2008/0085429 A1
(43) Pub. Date: Apr. 10, 2008

(54) Perpendicular Magentic Recording Medium and Method of Manufacturing the Same

(75) Inventors: Hoon-sang Oh, Seongnam-si (KR); Tae-hyo Lee, Cheonan-si (KR); Byung-kyu Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd, Suwon-si (KR)

(21) Appl. No.: 11/869,811

(22) Filed: Oct. 10, 2007

Related U.S. Application Data
(62) Division of application No. 11/065,152, filed on Feb. 25, 2005.

(30) Foreign Application Priority Data
Feb. 25, 2004 (KR) 10-2004-0012538

(51) Int. Cl. G11B 5/00

(52) U.S. Cl. 428/846

(57) ABSTRACT

Provided are a perpendicular magnetic recording medium having an underlayer between a substrate and a recording layer and a method of manufacturing the perpendicular magnetic recording medium. The method of manufacturing a perpendicular magnetic recording medium includes forming the underlayer of a plural-layer structure by at least 2 step processes under different deposition conditions. When using the underlayer formed by a 2-step manufacturing method, superior crystalline and high perpendicular magnetic anisotropy can be secured due to the lower underlayer, and the perpendicular magnetic recording layer having a high perpendicular coercivity and a small magnetic domain can be formed due to the underlayer beneath the recording layer.

### BACKGROUND OF THE INVENTION

This application claims the priority of Korean Patent Application No. 10-2004-0012538, filed on Feb. 25, 2004, in the Korean Intellectual Property Office, the disclosure of which is incorporated

A perpendicular magnetic recording method increases a recording density by arranging the magnetic direction of unit bits, which are recorded on a medium, in a perpendicular direction. In order to achieve a high density recording by the perpendicular magnetic recording method, a perpendicular magnetic recording medium with a recording layer having characteristics of high coercivity and perpendicular magnetic anisotropic energy, small crystalline grains, and small magnetic domain due to a low exchange coupling among the crystalline grains is required.

Here, the exchange coupling is a constant denoting the degree of magnetic interaction among the crystalline grains in the perpendicular magnetic recording layer, and it is preferable to have a small exchange coupling.

In general, the perpendicular magnetic recording medium is divided into a single magnetic layered structure and a double magnetic layered structure.

FIG. 1 is a sectional view illustrating a conventional single magnetic layered perpendicular magnetic recording medium.

Referring to FIG. 1, a conventional single magnetic layered perpendicular magnetic recording medium 10 includes a substrate 11, a perpendicular magnetic recording layer 17 on which magnetic information is recorded by a writing head, and an underlayer 15 (sometimes, referred to as “nonmagnetic underlayer” or “intermediate layer”), which is formed before depositing the perpendicular magnetic recording layer 17 to improve the crystalline alignment and magnetic property of the recording layer 17. The conventional perpendicular magnetic recording medium 10 is formed by arranging the perpendicular alignment underlayer 15, the recording layer 17, and a protective layer 19, on the substrate 11.

FIG. 2 is a sectional view illustrating a conventional double magnetic layered perpendicular magnetic recording medium.

Referring to FIG. 2, a conventional double magnetic layered perpendicular magnetic recording medium 20 includes a substrate 21, a perpendicular magnetic recording layer 27 on which magnetic information is recorded by a writing head, and an underlayer 25, which is formed before depositing the perpendicular magnetic recording layer 27 to improve the crystalline alignment and magnetic property of the recording layer 27. In addition, the conventional double magnetic layered perpendicular magnetic recording medium 20 includes a soft underlayer 23 (sometimes, referred to as “soft magnetic underlayer”) formed under the underlayer 25 to increase the field strength and the field gradient of a magnetic field, which is generated from a pole-type writing head. The conventional perpendicular magnetic recording medium 20 is formed by arranging the soft underlayer 23, the perpendicular alignment underlayer 25, the recording layer 27, and a protective layer 29, on the substrate 21.

In the case of the double magnetic layered perpendicular magnetic recording medium 20, the underlayer 25 may be referred to as an intermediate layer.

In the case of the double magnetic layered perpendicular magnetic recording medium 20, the soft underlayer 25 is an important element for enabling the high density recording.

In the cases of the single magnetic layered and double magnetic layered perpendicular magnetic recording media, the fine structure and the magnetic property of the recording layer are largely dependent on the material and the manufacturing method of the underlayer, which is formed under the recording layer.

As shown in FIGS. 1 and 2, the conventional perpendicular magnetic medium includes an underlayer, which is formed under a recording layer and affects the crystalline alignment and the magnetic characteristic of the recording layer when growing the recording layer. Here, the increase of the coercivity and the decrease in the size of the magnetic domain of the recording layer may be obtained by increasing the roughness of the underlayer through changing the deposition conditions of the underlayer. However, such a method increases the coercivity in a parallel direction and decreases squareness in a perpendicular direction and a saturation magnetization value.

It is understood that the increase of the coercivity in the parallel direction and the decrease of the squareness in the perpendicular direction mean the decrease of a perpendicular magnetic anisotropy due to the deterioration of crystalline property of the recording layer. In addition, it is understood that the decrease of the saturation magnetization value occurs because the internal defects of the recording layer, such as an initial growth layer or a void, increase during the growth of the recording layer due to the increase of the surface roughness of the underlayer.

### SUMMARY OF THE INVENTION

The present invention provides a perpendicular magnetic recording medium with an increased perpendicular coercivity while a perpendicular magnetic anisotropy is minimally sacrificed and a method of manufacturing the same.

According to an aspect of the present invention, there is provided a method of manufacturing a perpendicular magnetic recording medium which comprises a substrate, an underlayer, and a recording layer, wherein the underlayer is comprised of two or more consecutive nonmagnetic layers and one of the two or more consecutive layers is in contact with the recording layer, the method comprising the steps of:

forming each of the consecutive layers of the underlayer by employing different deposition conditions; and

forming the recording layer on the underlayer thereby the recording layer being in contact with the one layer of the underlayer.

According to another aspect of the present invention, there is provided a perpendicular magnetic recording medium manufactured by the above-described method.

According to embodiments of the present invention, the surface roughness of the layer of the underlayer, which is in contact with the recording layer may be greater than the surface roughness of the other consecutive layers of the underlayer. In this case, the layer which is in contact with the recording layer may be formed under a higher deposition pressure and/or lower deposition power than the other layers of the underlayer.

Each of the consecutive layers of the underlayer may be formed of the same material. The layer of the underlayer, which is in contact with the recording layer may have a smaller thickness than the other layers of the underlayer. The total thickness of the underlayer of the plural-layer structure may be about 40 nm or less.

The recording layer may be formed of any one of CoCrPtX containing Co as a main component, FePt-based material and CoPt ordered alloy where X is Nb, B, Ta, O, or SiO2

The perpendicular magnetic recording medium may have any one of a single magnetic layer structure and a double magnetic layer structure. The underlayer may be formed of at least one of Ru, an alloy thereof, a CoCr alloy, Pt, an alloy thereof, Pd, an alloy thereof, Ti, and an alloy thereof.

The perpendicular magnetic recording medium may further comprise a seed layer under the underlayer to facilitate the initial growth of the underlayer. The seed layer may be formed between the underlayer and the substrate when the perpendicular magnetic recording medium has a single magnetic layer structure, or between the underlayer and the soft underlayer when the perpendicular magnetic recording medium has a double magnetic layer structure. The seed layer may be formed of any one of Ta, Pt, Pd, Ti, Cr, and alloys thereof.

### BRIEF DESCRIPTION OF THE DRAWINGS

The above and other features and advantages of the present invention will become more apparent by describing in detail exemplary embodiments thereof with reference to the attached drawings in which:

FIG. 1 is a sectional view illustrating a conventional single magnetic layered perpendicular magnetic recording medium;

FIG. 2 is a sectional view illustrating a conventional double magnetic layered perpendicular magnetic recording medium;

FIG. 3A is a sectional view illustrating a double magnetic layered perpendicular magnetic recording medium according to a first embodiment of the present invention;

FIG. 3B is a sectional view illustrating a single magnetic layered perpendicular magnetic recording medium according to a second embodiment of the present invention;

FIGS. 4A through 4E illustrate the changes in the size of a magnetic domain of a recording layer when forming the recording layer after forming an underlayer at sputtering pressures of 5, 10, 20, 30, and 40 mTorr, respectively;

FIGS. 5A through 5E are graphs illustrating in-plane and perpendicular magnetic hysteresis loops of a recording layer having a magnetic domain whose size is changed according to the changes in the sputtering pressure as shown in FIGS. 4A through 4E;

FIG. 6A is a graph illustrating changes in in-plane and perpendicular coercivities according to the changes in the sputtering pressure;

FIGS. 6B and 6C are graphs illustrating changes in squareness and saturation magnetization according to the changes in the sputtering pressure;

FIG. 7 is a graph illustrating in-plane and perpendicular magnetic hysteresis loops of a CoCrPt—SiO2 recording layer formed on a Ru underlayer, which is formed by a two-step underlayer manufacturing method according to the present invention; and

FIGS. 8A through 8C are graphs illustrating coercivities, squareness, and saturation magnetization values of a conventional perpendicular magnetic recording medium and a perpendicular magnetic recording medium according to the present invention.

### DETAILED DESCRIPTION OF THE INVENTION

The present invention will now be described more fully with reference to the accompanying drawings, in which exemplary embodiments of the invention are shown.

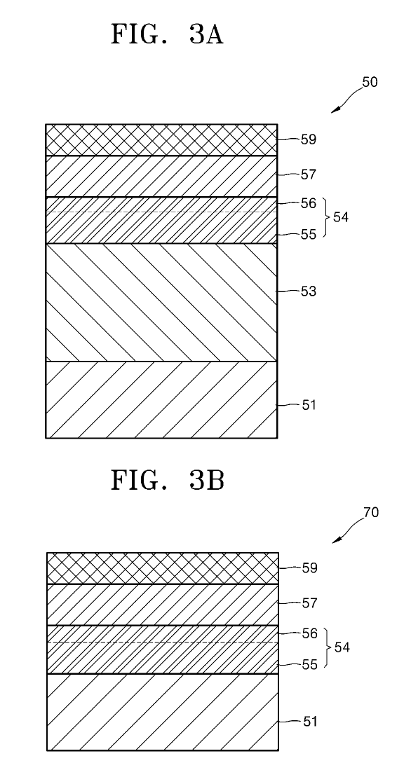

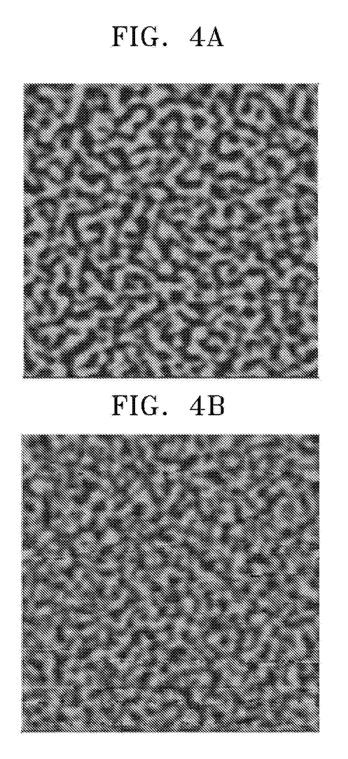

A perpendicular magnetic recording medium according to the present invention has a multi-layered nonmagnetic underlayer, which is deposited by using at least two steps, as shown in FIG. 3A or 3B. Here, a first underlayer is formed by depositing to a predetermined thickness at a low sputtering pressure, and a second underlayer is formed by depositing to a smaller thickness than the first underlayer at a high sputtering pressure using the same material as the first underlayer. Thus, the first underlayer has an excellent crystalline property and a smooth surface, and the second underlayer has a properly increased surface roughness.

FIGS. 3A and 3B are sectional views illustrating perpendicular magnetic recording media according to first and second embodiments of the present invention.

Referring to FIGS. 3A and 3B, the perpendicular magnetic recording medium according to the present invention includes a recording layer 57 and an underlayer 54 of a multi-layered structure formed on a substrate 51.

The perpendicular magnetic recording medium 50 according to the first embodiment of the present invention shown in FIG. 3A includes a soft underlayer 53 formed between the substrate 51 and the underlayer 54. The perpendicular magnetic recording medium 50 is formed by depositing the soft underlayer 51, first and second underlayers 55 and 56, the perpendicular magnetic recording layer 57, and a protective layer 59, on the substrate 51.

Here, the soft underlayer 53 is formed to increase the field strength and the field gradient of a magnetic field, which is generated from a pole type writing head during a magnetic recording operation.

In the double magnetic layered perpendicular magnetic recording medium 50 of FIG. 3A, the soft underlayer 53 enables a high density recording.

FIG. 3B is a sectional view illustrating a single magnetic layered perpendicular magnetic recording medium 70 according to the second embodiment of the present invention.

In the exemplary embodiments shown in FIGS. 3A and 3B, the protective layer 59 may be formed on the perpendicular magnetic recording layer 57 to protect the perpendicular magnetic recording layer 57 from the outside. A lubricant film (not shown) may be further formed on the protective layer 59 to reduce the abrasion of a magnetic head (not shown) and the protective layer 59 from the collision and lubrication between the magnetic head and the protective layer 59.

On the perpendicular magnetic recording layer 57, information is recorded by arranging the magnetization of unit bits, which are recorded by a writing head of the magnetic head, in a perpendicular direction. Here, the perpendicular magnetic recording layer 57 is formed of a ferromagnetic material of a Co-based and/or an Fe-based alloy having an excellent perpendicular magnetic anisotropy.

For example, the perpendicular magnetic recording layer 57 may be formed of a CoCrPtX-based material containing Co as a main component, wherein X may be B, Nb, Ta, O, or SiO2, a FePt-based material or CoPt ordered alloy.

The underlayer 54 having the plural-layer structure includes the first and second underlayers 55 and 56 that are formed under different deposition conditions. The underlayer 54 may be comprised of more than two layers. One of the multiple layers of the underlayer 54 (e.g., underlayer 56 as shown in FIGS. 3A and 3B) is formed to be in contact with the perpendicular magnetic recording layer 57.

Hereafter, as an example, the underlayer 54 according to the present invention having a double layered structure will be described.

The layer of the underlayer 54, which is in contact with the perpendicular magnetic recording layer 57, for example, the second underlayer 56 in FIGS. 3A and 3B, has a surface rougher than the surface of the other underlayer, for example, the first underlayer 55 in FIGS. 3A and 3B. When the underlayer 54 has more than two layers, the layer which is in contact with the perpendicular recording layer 57 has a rougher surface than any other layers of the underlayer 54.

Each of the layers of the underlayer 54 may be formed of the same material. For example, the first and second underlayers 55 and 56 may be formed of at least one material selected from Ru, an alloy thereof, a CoCr alloy, Pt, an alloy thereof, Pd, an alloy thereof, Ti, and an alloy thereof, when the perpendicular magnetic recording layer 57 is formed of a CoCrPtX-based material. Here, it is preferable that the first and second underlayers 55 and 56 are formed of a material including Ru, because Ru is a non-magnetic single element metal having the smallest lattice constant difference from CoCrPtX.

The first and second underlayers 55 and 56 that may be referred to as an intermediate layer in the double magnetic layered perpendicular magnetic recording medium are formed to improve the crystalline alignment and the magnetic property of the perpendicular magnetic recording layer 57. In the double magnetic layered perpendicular magnetic recording medium 50, the first and second underlayers 55 and 56 provide a magnetic break between the perpendicular magnetic recording layer 57 and the soft underlayer 53.

It is preferable that the first and second underlayers 55 and 56 are formed to increase coercivity without sacrificing the perpendicular magnetic anisotropy and to reduce a magnetic domain size in order to obtain the perpendicular magnetic recording medium of high recording density.

Thus, the second underlayer 56, which is located beneath the perpendicular magnetic recording layer 57, may be formed to have greater surface roughness than the first underlayer 55 by employing different deposition conditions.

Here, when the first and second underlayer 55 and 56 are deposited by sputtering, the deposition conditions affecting the surface roughness are a sputtering gas pressure in a deposition chamber and an electric power, i.e., a sputtering power, applied to a gun on which a target is mounted. The target is a base material used for spurring deposition. In order to perform sputtering, the electric power may be applied to the mount and a sputtering chamber may be grounded.

In general, when forming a metal film by sputtering, the surface of the resulting film is rougher than the films produced at a lower sputtering gas pressure and/or a higher sputtering power, because the energy of a deposition material, which is sputtered from the sputtering target and reached to a substrate, is low under the condition of the high sputtering gas and/or the low sputtering power.

The first underlayer 55 may be formed at a low sputtering pressure and/or a high sputtering power thereby providing the underlayer 55 with a smooth surface and an excellent crystalline structure with well-developed preferred orientation.

The second underlayer 56 may be formed of the same material as the first underlayer 55 under the conditions of a sputtering pressure which is higher than that employed for forming the first underlayer 55 and/or a sputtering power which is lower than that employed for forming the first underlayer 55. Generally, the layer which is in contact with the recording layer may be formed at a deposition pressure of 15 mTorr or higher and the other layer of the underlayer may be formed at a deposition pressure of 15 mTorr or lower. For example, in one exemplary embodiment of the present invention, the first underlayer 55 and the second underlayer 56 may be formed at a sputtering pressure of about 5 mTorr and about 20 mTorr, respectively.

The deposition power difference between the one layer which is in contact with the recording layer and the other layer of the underlayer may be at least 50 W or greater.

Here, it is preferable that the thickness of the second underlayer 56 is smaller than that of the first underlayer 55, thus the surface roughness of the second underlayer 56 is increased to the level predetermined by a manufacturer of the recording medium.

The second underlayer 56 formed as described above renders the formation of the perpendicular magnetic recording layer 57 having a high perpendicular coercivity and a small magnetic domain size.

Here, in the case of the double magnetic layered perpendicular magnetic recording medium 50 shown in FIG. 3A, it is preferable that the second underlayer 56 is formed to a thickness of about 10 nm or less, for example, about 5 mm, the first underlayer 55 is formed to a thickness of about 30 nm or less, and the total thickness of the first and second underlayers 55 and 56 is about 40 nm or less.

When the total thickness of the multi-layered underlayer located between the recording layer and the soft underlayer is too large, the distance from the pole type writing head to the soft underlayer becomes too large. Accordingly, the functions of the soft underlayer, such as improving the field strength and the field gradient of a recording magnetic field, may not be satisfactorily performed, thus the high density recording cannot be obtained. Thus, it is preferable that the total thickness of the first and second underlayers 55 and 56 is about 40 nm or less.

The thicknesses of the first and second underlayers 55 and 56 are not limited to the above-described thicknesses. The thicknesses of the first and second underlayers 55 and 56 may vary as long as the characteristics of the perpendicular magnetic recording medium that are required in the present invention are secured. Also, the total thickness of the underlayer 54 may be about 40 nm or more. When the multi-layered underlayer 54 has more than two layers, the thickness of a layer which is in contact with the perpendicular magnetic recording layer is greater than any other layers of the underlayer 54.

As described above, each of layers of the underlayer 54 of the perpendicular magnetic recording medium 50 or 70 according to the present invention is formed by performing the deposition under different conditions, and the surface roughness of the second underlayer 56, which is in contact with the perpendicular magnetic recording layer 57, is greater than the surface roughness of the first underlayer 55.

More specifically, in the first deposition of forming the underlayer 54 in the perpendicular magnetic recording medium 50 or 70 according to the present invention, the first underlayer 55 is deposited under the conditions of the low sputtering pressure and/or the high electric power, whereby the first underlayer 55 having a superior crystalline and smooth surface is obtained. In the second deposition, the second underlayer 56 is deposited under the conditions of the high sputtering pressure and/or the low electric power by using the same material as the first underlayer 55. Here, the second underlayer 56 is formed to have a thickness that is smaller than the first underlayer 55, whereby the surface roughness of the second underlayer 56 is increased to a proper level.

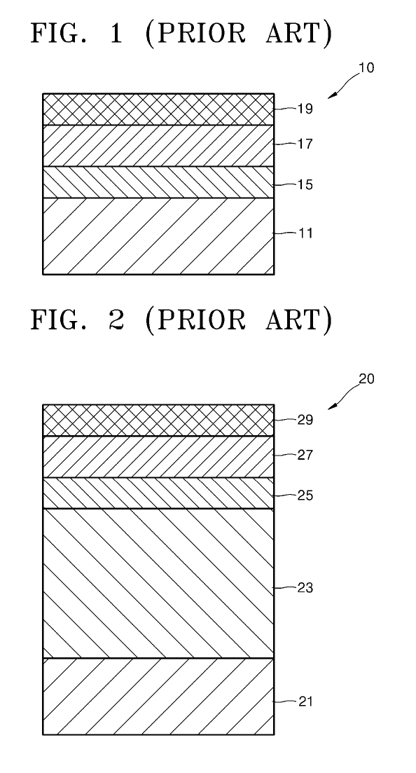

By employing a multi-layered underlayer, of which each layer is formed under different deposition conditions as described above, the magnetic properties of the recording layer 57 could be improved compared to when using a conventional single-layered underlayer 15 or 25 of FIG. 1 or 2 that is formed by a single deposition step.

More specifically, the first underlayer 55 formed under the low sputtering pressure secures the excellent crystalline and perpendicular magnetic anisotropy. The second underlayer 56 having the rough surface increases the perpendicular coercivity and decreases the magnetic domain. Here, since the first and second underlayers 55 and 56 are formed of the same material, the second underlayer 56 may be grown on the first underlayer 55 in an epitaxial growth manner while increasing the surface roughness.

The surface roughness of the second underlayer 56 can be controlled by changing the sputtering condition like the sputtering pressure (an elevated sputtering pressure increases the surface roughness), sputtering power (a lowered sputtering power decreases the surface roughness) and the thickness of the second underlayer 56 (a smaller thickness increases the surface roughness).

The perpendicular magnetic recording medium 50 or 70 according to the present invention has the underlayer 54, which is formed by performing depositions at least twice, thus the first underlayer 55 secures the excellent crystalline quality and perpendicular magnetic anisotropy and the second underlayer 56 enables the perpendicular magnetic recording layer 57 to have the high perpendicular coercivity and the small magnetic domain. Accordingly, the perpendicular magnetic recording layer 57 may secure an excellent thermal stability, a high recording density, and an excellent signal-to-noise ratio (SNR).

In the description of the perpendicular magnetic recording media of FIGS. 3A and 3B, the embodiments of the perpendicular magnetic recording medium 50 or 70 according to the present invention have a double layered underlayer 54, in other words, the first and second underlayers 55 and 56; however, the scope of the present invention is not limited to the double layered underlayer. For example, the perpendicular magnetic recording medium 50 or 70 according to the present invention may have an underlayer with three or more layers. Here, the surface roughness of the layer which is in contact with the perpendicular recording layer 57 is greater than the surface roughness of other underlayers.

On the other hand, the perpendicular magnetic recording medium 50 or 70 according to the present invention may further include a seed layer (not shown) under the underlayer 54 in order to induce the successful growth of intended crystal structure from the initial stage of growing the underlayer 54. Here, the seed layer is formed between the underlayer 54 and the substrate 51 in the case of the single layered perpendicular magnetic recording medium 70, and between the underlayer 54 and the soft underlayer 53 in the case of the double layered perpendicular magnetic recording medium 50. The seed layer is formed of at least one material selected from Ta, Pt, Pd, Ti, Cr, and alloys thereof.

Hereafter, the properties of the perpendicular magnetic recording media that have a conventional underlayer of a single layer structure and an underlayer of a double layer structure according to the present invention are compared in order to prove that the multi-layered underlayer according to the present invention effectively increases the perpendicular coercivity without sacrificing the perpendicular magnetic anisotropy and the saturation magnetization value.

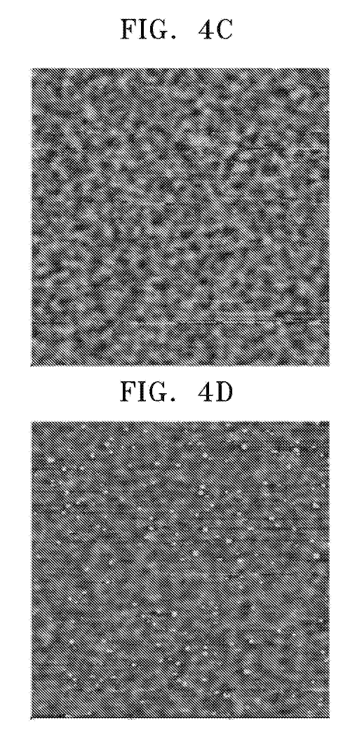

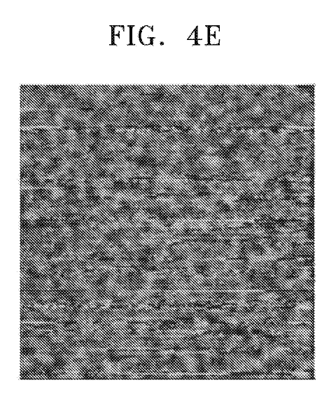

FIGS. 4A through 6C illustrate changes in the magnetic properties of the recording layer according to the changes in the sputtering pressure of a Ru-based underlayer in a CoCrPt—SiO2 perpendicular magnetic recording medium. Here, FIGS. 4A through 6C illustrate results of experiments performed on the single layered perpendicular magnetic recording medium, which was formed under fixed recording layer deposition conditions except for the sputtering pressure of the underlayer. More specifically, the perpendicular magnetic recording medium was formed by forming a Ta seed layer to a thickness of 5 nm on a glass substrate, forming a Ru underlayer to a thickness of 30 nm by a conventional method, and forming a CoCrPt—SiO2 perpendicular magnetic recording layer.

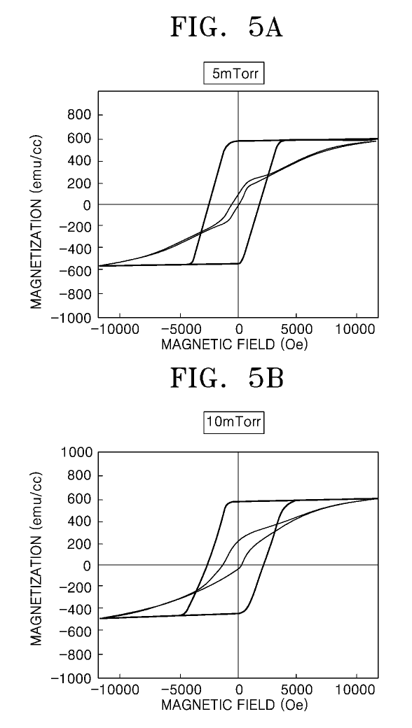

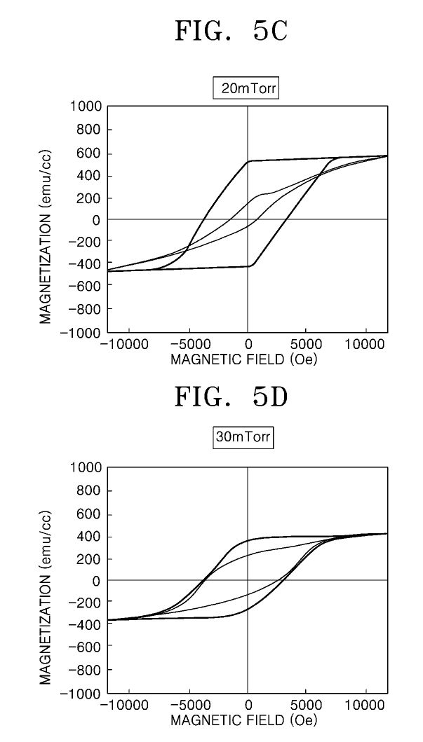

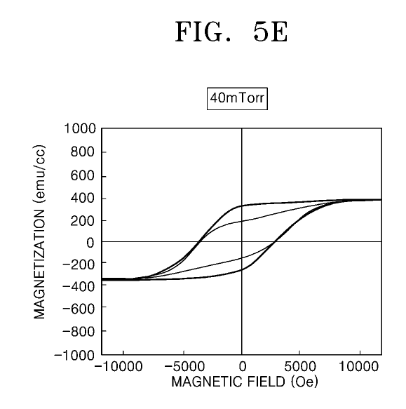

FIGS. 4A through 4E illustrate the changes in the size of the magnetic domain of the recording layer on the Ru underlayers that were formed under the sputtering pressures of 5, 10, 20, 30 and 40 mTorr. FIGS. 5A through 5E are graphs illustrating the in-plane and perpendicular magnetic hysteresis loops for the recording layer having the magnetic domain, which was changed in size, according to the sputtering pressure as shown in FIGS. 4A through 4E.

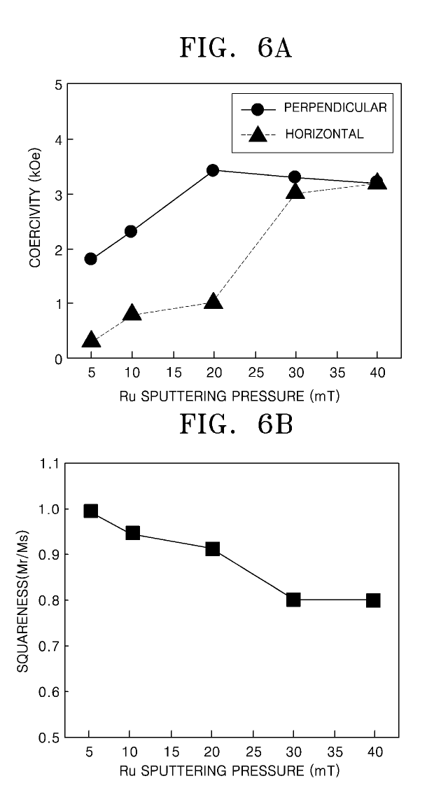

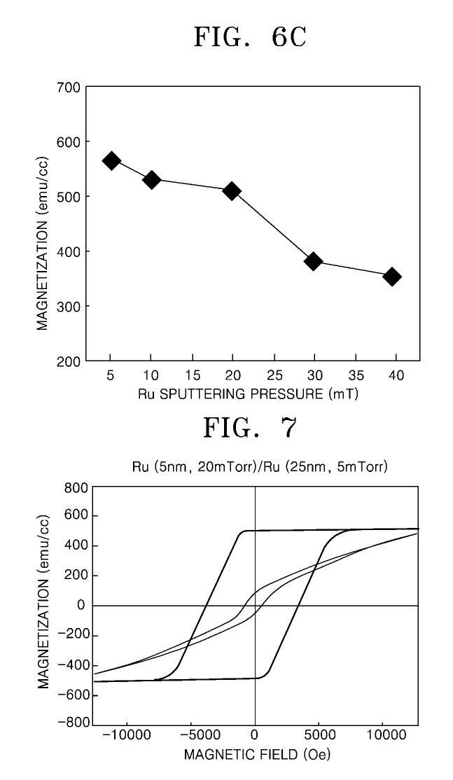

FIG. 6A is a graph illustrating changes in the in-plane and perpendicular coercivities of the recording layer according to the changes in the sputtering pressure of the Ru underlayer. FIGS. 6B and 6C are graphs illustrating changes in the squareness and the saturation magnetization of the recording layer according to the changes in the sputtering pressure of the Ru underlayer.

Referring to FIGS. 4A through 5E, even when the deposition conditions except for the sputtering pressure of the Ru underlayer are fixed, the perpendicular coercivity is increased and the size of the magnetic domain is decreased as the sputtering pressure of the Ru underlayer is increased.

It is believed that the surface roughness of the Ru underlayer is increased by increasing the sputtering pressure of the underlayer, thus a large amount of pinning sites that interrupt the movement of a magnetic domain wall is generated in the recording layer, which is grown on the Ru underlayer, thereby resulting in blocking the propagation of a reversed domain when a magnetization is reversed.

By increasing the sputtering pressure of the underlayer, the change in the surface morphology of the underlayer is induced to increase the perpendicular coercivity of the recording layer and reduce the magnetic domain.

However, as shown in FIGS. 6A through 6C, as the sputtering pressure of forming the underlayer is increased, a contrary effect that the in-plane coercivity increases and the squareness and the magnetization value decrease occurs.

It is believed that the increase of the in-plane coercivity and the decrease of the perpendicular squareness mean the decrease of the perpendicular magnetic anisotropy due to the deterioration of the crystalline property of the recording layer, and the decrease of the saturation magnetization occurs because internal defects, such as an initial growth layer or void, increase when growing the recording layer due to the increase of the surface roughness of the underlayer.

Accordingly, it is difficult to increase the perpendicular coercivity while minimizing the sacrifice of the perpendicular magnetic anisotropy in the conventional perpendicular magnetic recording medium having the underlayer of the single layer structure.

FIG. 7 is a graph illustrating the in-plane and perpendicular magnetic hysteresis loops of the CoCrPt—SiO2 recording layer formed on the multi-layered Ru underlayer, which was formed by a two-step underlayer manufacturing method according to the present invention.

The graph of FIG. 7 denotes the result of an experiment in which the first underlayer 55 was deposited to a thickness of 25 nm under a sputtering pressure of 5 mTorr by using Ru and the second underlayer 56 was formed to a thickness of 5 nm under a sputtering pressure of 20 mTorr by using Ru thereon.

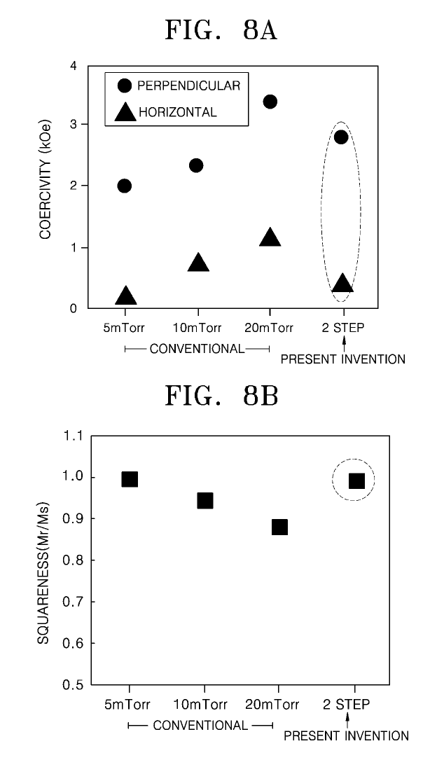

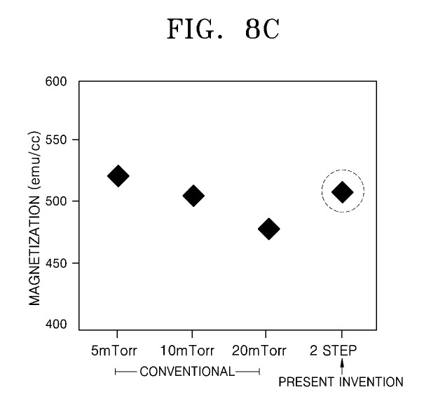

FIGS. 8A through 8C are graphs illustrating coercivities, squareness, and saturation magnetization values of the conventional perpendicular magnetic recording medium and the perpendicular magnetic recording medium according to the present invention.

Here, the perpendicular and in-plane coercivities, the squareness in perpendicular direction, and the saturation magnetization values for the sputtering pressures of 5, 10, and 20 mTorr were obtained from the perpendicular magnetic recording medium manufactured by the conventional method and correspond to the data values shown in the graphs of FIGS. 6A through 6C. In addition, the perpendicular and in-plane coercivities, the squareness in perpendicular direction, and the saturation magnetization value for 2-step were obtained from the perpendicular magnetic recording medium manufactured according to the present invention, which had the underlayer formed by 2-step deposition and a recording layer thereon and generated the magnetic hysteresis loops of FIG. 7.

In the case of the perpendicular magnetic recording medium manufactured by the conventional method, as the sputtering pressure of the Ru underlayer increased from 5 mTorr to 20 mTorr, the perpendicular and in-plane coercivities increased concurrently and the perpendicular squareness decreased, as shown in FIGS. 8A and 8B, indicating that the perpendicular magnetic anisotropy gradually decreases as the sputtering pressure of the underlayer increases. In addition, referring to FIG. 8C, in the case of the perpendicular magnetic recording medium manufactured by the conventional method, as the sputtering pressure of the underlayer increased, the saturation magnetization value of the recording layer gradually decreased.

On the other hand, when the first underlayer 55 was deposited to a thickness of 25 nm under a sputtering pressure of 5 mTorr by using Ru and the second underlayer 56 was deposited to a thickness of 5 nm under a sputtering pressure of 20 mTorr using Ru by the 2-step underlayer manufacturing method according to the present invention, the perpendicular coercivity increased without a great increase in in-plane coercivity. In addition, the squareness and the saturation magnetization value did not decrease compared to the case of the conventional Ru underlayer, which was formed to a thickness of 30 nm under an ion sputtering pressure of 5 mTorr.

Thus, the perpendicular coercivity can be effectively increased without sacrificing the perpendicular anisotropy and the saturation magnetization when at least-2-step underlayer deposition method according to the present invention is used.

Although experiments and discussions were made with respect to the single magnetic layered perpendicular magnetic recording medium, substantially the same result can be obtained from the double magnetic layered perpendicular magnetic recording medium.

Accordingly, the 2-step underlayer manufacturing method according to the present invention can be applied to the double magnetic layered structure including the soft underlayer, as well as the single magnetic layered structure.

As described above, the underlayer 54 is formed by 2-step manufacturing method in the single magnetic layered perpendicular magnetic recording medium and the double magnetic layered perpendicular magnetic recording medium.

When using the underlayer formed by the 2-step manufacturing method, the perpendicular magnetic recording layer having a high perpendicular coercivity and a small magnetic domain can be formed due to the layer which is in contact with the recording layer, and an excellent crystalline quality and a high perpendicular magnetic anisotropy can be secured due to the other layer of the multi-layered underlayer. Accordingly, the perpendicular magnetic recording layer can secure an excellent thermal stability, a high recording density, and an excellent SNR.

While the present invention has been particularly shown and described with reference to exemplary embodiments thereof, it will be understood by those of ordinary skill in the art that various changes in form and details may be made therein without departing from the spirit and scope of the present invention as defined by the following claims.

1-12. (canceled)

12. A perpendicular magnetic recording medium comprising a substrate, a nonmagnetic underlayer, and a recording layer, wherein the underlayer is comprised of two or more consecutive nonmagnetic layers and one of the two or more consecutive layers is in contact with the recording layer, the perpendicular magnetic recording medium being manufactured by a method comprising:
forming each of the consecutive layers of the underlayer by employing different deposition conditions; and
forming the recording layer on the underlayer so that the recording layer is in contact with the one layer of the underlayer.

13. The perpendicular magnetic recording medium of claim 12, wherein the surface roughness of the one layer which is in contact with the recording layer is greater than the surface roughness of the other layers of the underlayer.

14. The perpendicular magnetic recording medium of claim 13, wherein the one layer which is in contact with the recording layer is formed under conditions in which the deposition pressure employed to form the one layer is higher than those employed to form other layers of the underlayer, and/or the deposition power employed to form the one layer is lower than those employed to form other layers of the underlayer.

15. The perpendicular magnetic recording medium of claim 12, wherein the one layer which is in contact with the recording layer is formed under conditions in which the deposition pressure employed to form the one layer is higher than those employed to form other layers of the underlayer, and/or the deposition power employed to form the one layer is lower than those employed to form other layers of the underlayer.

16. The perpendicular magnetic recording medium of claim 12, wherein each of the consecutive layers of the underlayer is formed of the same material.

17. The perpendicular magnetic recording medium of claim 12, wherein the one layer which is in contact with the recording layer has a smaller thickness than the other layers of the underlayer.

18. The perpendicular magnetic recording medium of claim 17, wherein the total thickness of the underlayer is about 40 nm or less.

19. The perpendicular magnetic recording medium of claim 12, wherein the recording layer is formed of any one of CoCrPtX containing Co as a main component, FePt-based material and CoPt ordered alloy where X is Nb, B, Ta, O, or SiO₂.

20. The perpendicular magnetic recording medium of claim 12, wherein the perpendicular magnetic recording medium further comprises a soft magnetic underlayer formed under the underlayer.

21. The perpendicular magnetic recording medium of claim 20, wherein the underlayer is formed of at least one of Ru, an alloy thereof, a CoCr alloy, Pt, an alloy thereof, Pd, an alloy thereof, Ti, and an alloy thereof.

22. The perpendicular magnetic recording medium of claim 12, which further comprises a seed layer formed under the underlayer, wherein the seed layer is formed of any one of Ta, Pt, Pd, Ti, Cr, and alloys thereof.

23-26. (canceled)

27. The perpendicular magnetic recording medium of claim 14, wherein the one layer which is in contact with the recording layer is formed at a deposition pressure of 15 mTorr or higher and the other layer of the underlayer is formed at a deposition pressure of 15 mTorr or lower.

28. The perpendicular magnetic recording medium of claim 14, wherein the consecutive layers of the underlayer are formed such that the deposition power difference between the one layer which is in contact with the recording layer and the other layer of the underlayer is at least 50 W or greater.

29. The perpendicular magnetic recording medium of claim 15, wherein the one layer which is in contact with the recording layer is formed at a deposition pressure of 15 mTorr or higher and the other layer of the underlayer is formed at a deposition pressure of 15 mTorr or lower.

30. The perpendicular magnetic recording medium of claim 15, wherein the consecutive layers of the underlayer are formed such that the deposition power difference between the one layer which is in contact with the recording layer and the other layer of the underlayer is at least 50 W or greater.
